(19) United States
(12) Patent Application Publication
(10) Pub. No.: US 2003/0158773 A1
(43) Pub. Date: Aug. 21, 2003

(54) Objective value discovery method

(76) Inventor: Tracy Brunner, Ramona, KS (US)

Correspondence Address: THOMAS B. LUEBBERING, HOVEY WILLIAMS LLP, Suite 400, 2405 Grand, Kansas City, MO, 64108, US

(21) Appl. No.: 10/078,082

(22) Filed: Feb. 15, 2002

(51) Int. Cl. G06F 17/60

(52) U.S. Cl. 705/10

(57) ABSTRACT

A method for determining a live animal value broadly comprises the steps of determining a total retail value (TRV) which represents beef demand and combining the TRV with adjustments for supply, cost, and other factors. These adjustments preferably include a weekly beef production adjustment (WPA), an energy cost adjustment (ECA), a labor cost adjustment (LCA), an interest rate adjustment (IRA), a feed cost adjustment (FCA), and an expected value adjustment (EVA). Together with the TRV, these adjustments are variable with market conditions but are measurable. Since the TRV and the adjustments are measurable, the live animal value can be objectively determined, optimizing sales transactions between a cattle producer and a beef processor. The live animal value can be adjusted according to an animal's individual merits of quality. The animal's weight is determined and that weight is multiplied by the live animal value, to determine a price for the animal.

### BACKGROUND OF THE INVENTION

1. Field of the Invention

The present invention relates to a method of determining a value for livestock. More particularly, the present invention relates to an efficient method of determining a live animal value for livestock accounting for demand, supply, cost, and other factors.

2. Description of Prior Art

The United States beef industry produced over 26.7 billion pounds of beef with a retail value of over $58.6 billion and United States consumers consumed 69.5 lbs. of beef at a cost of $213 per capita in the year 2000. Such an industry is comprised of millions of sales transactions each day. Obviously, optimization of these sales transactions can improve efficiency of the entire beef industry.

Sales transactions typically occur at all levels from a cattle producer to a beef processor, to a retailer, and finally to a consumer. Sales transactions involving a retailer comprise a very broad market with little to no standardization. Thus, optimizing retail sales transactions would prove difficult.

Sales transactions from a cattle producer to a beef processor are more standardized and are a prominent point of value discovery. These sales transactions are bounded on each side by segments of the beef industry that require specific production facilities and equipment. Each segment is very sensitive to economies of scale and can benefit from optimization of their sales transactions.

Early in the history of the beef industry, cattle was sold largely on a per head basis from a cattle producer to a dealer who would ship and sell the cattle to a packing plant or a beef processor. An individual animal's physiologically optimum harvest point was often compromised for economic or convenience considerations. For example, a cattle producer might have sold an animal early because they had several other animals ready for sale and it was more convenient to sell the animal with the others, instead of waiting until the animal was ready. Harvest points other than an optimum harvest point created variation not only in cattle weight and yield, but also in product quality. Overtime, consumers grew weary of consuming larger and still larger amounts of variable quality beef. This led to reduced consumer satisfaction and demand for beef.

Some cattle producers and beef processors believe a greater focus on product quality will bring greater consumer satisfaction and believe greater coordination in genetic selection, production, and processing will yield a superior quality product and a more satisfied consumer. To accomplish this, some cattle producers have begun selling cattle on a yield and quality basis, rather than on a per pound of live weight basis.

Selling cattle on a yield and quality basis is complex, since it requires a negotiated price for each individual animal or groups of animals. Many cattle producers and beef processors believe such negotiation is burdensome and nonproductive. Therefore, prices are often based on an average of similar negotiated sales transactions that week. This practice allegedly allows increased production with a quality focus and further enhances overall efficiency.

However, as more sales transactions occur on an average negotiated sales basis, the quantity of negotiated sales transactions becomes smaller. Thus, there are now fewer negotiated sales transactions on which to base averaging transactions. Many in the industry therefore perceive this practice as “thinner”, resulting in prices that are not representative of actual prices of a negotiated sale.

Currently, sales transactions are based on a live cash price, which is a price for a live unprocessed animal. The live cash price is either negotiated or based on an average of negotiated sales. The live cash price can vary drastically. For instance, from March of 1993 and April of 1996 an average live animal price fell 33%. Then, through January of 2001, the average live animal price rose 45%. This put the 2001 average live animal price below 1993 levels, even before accounting for eight years of inflation. Such large price variations are difficult for the beef industry to absorb.

In response, some have proposed basing a live animal value on a United States Department of Agriculture quoted wholesale beef price. However, many beef processors contend this would place them in a position of competitive disadvantage with retailers. Additionally, many cattle producers and beef processors believe pricing based on a wholesale beef price may prevent any price increase available by selling to the highest price. Furthermore, with a live animal value dependent on a wholesale beef price, a beef processor has less incentive to sell meat at higher prices, since that would directly and proportionally increases the beef processor's raw product cost.

Accordingly, there is a need for an efficient method for determining a live animal value for livestock accounting for demand, supply, cost, and other factors that overcomes the limitations of the prior art.

### SUMMARY OF THE INVENTION

The present invention overcomes the above-identified problems and provides a distinct advance in the art. More particularly, the present invention relates to an efficient method of determining a live animal value for livestock accounting for demand, supply, cost, and other factors.

The preferred method broadly comprises the steps of determining a total retail value (TRV) which represents beef demand and combining the TRV with adjustments for supply, cost, and other factors. These adjustments preferably include a weekly beef production adjustment (WPA), an energy cost adjustment (ECA), a labor cost adjustment (LCA), an interest rate adjustment (IRA), a feed cost adjustment (FCA), and an expected value adjustment (EVA). Together with the TRV, these adjustments are variable with market conditions but are measurable. Since the TRV and the adjustments are measurable, the live animal value can be objectively determined, optimizing sales transactions between a cattle producer and a beef processor.

The TRV is preferably based upon a recent composite retail price survey posted by the United States Department of Agriculture (U.S.D.A.). The composite retail price survey cannot be used alone, since it does not account for a value of byproducts. Therefore, a wholesale byproduct value is added to the composite retail price survey to form the TRV. The TRV is multiplied by a total retail value coefficient (TRVc).

The WPA is used to account for supply factors and includes a weekly beef production (WBP) and a weekly beef production coefficient (WBPc). The U.S.D.A. also provides information on pounds of beef produced. This information is preferably used as the WBP.

The ECA is used to account for energy costs associated with processing and transporting beef and includes an energy cost index (ECI) and an energy cost index coefficient (ECIc). The United States Department of Commerce (U.S.D.C.) provides information on current energy costs. This information is preferably used as the ECI.

The LCA is used to account for labor costs associated with processing beef and comprises a labor cost index (LCI) and a labor index coefficient (LCIc). The U.S.D.C.'s Bureau of Labor Statistics provides information on wages paid to meat packing workers. This information is preferably used as the LCI.

The IRA is used to account for lost rates of return funds tied up in large inventories rather than being invested and includes an interest rate index (IRI) and an interest rate index coefficient (IRIc). The United States Federal Reserve provides a prime rate. The prime rate is preferably used as the IRI.

The FCA is used to account for feed costs associated with feeding animals and includes a feed index (FCI) and a feed cost index coefficient (FCIc). The USDA conducts a weekly composite corn survey. The survey is preferably used as the FCI.

The EVA is used to account for an expected future animal value and includes an expected value index (EVI) and an expected value index coefficient (EVIc). Cattle futures contracts are traded on the Chicago Mercantile Exchange. EVI is preferably derived from cattle futures contract prices as traded on the Chicago Mercantile Exchange.

Additionally, while these adjustments account for variations in supply, costs, and other factors, it has been found that a constant value (CV) is also needed. The CV provides a standard offset to the live animal value and prevents the TRV or the adjustments from invalidating the live animal value, when one factor experiences an abnormal variance.

The live animal value can be adjusted according to an animal's individual merits of quality and is a price per one hundred pounds. The animal's weight is determined and that weight is multiplied by the live animal value, to determine a price for the animal. For example, for a 900 pound steer, the beef processor would be expected to pay the cattle producer the live animal value multiplied by 9.

### BRIEF DESCRIPTION OF THE DRAWINGS

A preferred embodiment of the present invention is described in detail below with reference to the attached drawing figures, wherein:

FIG. 1 is a flow chart showing a method for determining a live value for livestock according to the present invention.

### DETAILED DESCRIPTION OF A PREFERRED EMBODIMENT

The preferred method of determining a live animal value for livestock according to the present invention broadly comprises the steps of determining a total retail value (TRV) which represents beef demand and combining the TRV with adjustments for supply, cost, and other factors. These adjustments preferably include a weekly beef production adjustment (WBPA), an energy cost adjustment (ECA), a labor cost adjustment (LCA), an interest rate adjustment (IRA), a feed cost adjustment (FCA), and an expected value adjustment (EVA). Together with the TRV, these adjustments are variable with market conditions but are measurable. Since the TRV and the adjustments are measurable, the live animal value can be objectively determined, optimizing sales transactions between a cattle producer and a beef processor.

The TRV is determined by analyzing retail beef prices. Retail beef prices are a preferred basis for a number of reasons. A first reason is that retail beef prices change little throughout and across years. Retail beef prices only fell 9% between May of 1993 and March of 1996 and only rose 16% through January of 2001. As can be seen, retail beef prices actually rose in absolute terms, accounting for inflationary influences.

A second reason is that retail beef prices are publically available and easily attainable. The United States Department of Agriculture (U.S.D.A.) currently conducts a weekly composite retail price survey. The composite retail price survey is available on the U.S.D.A.'s website and through other sources.

A third and final reason is that consumers are the true and final evaluator of value. Pricing based on a consumer assigned value will prove superior to any other standard.

Since the composite retail price survey is available and all significant costs of transfer, processing, transformation, and transportation are known, the live animal value can be objectively calculated. The live animal value can be used as an initial value of an individual animal and the animal's byproducts. Additionally, the live animal value can be adjusted according to the animal's individual quality merits. The live animal value is calculated in U.S. dollars per pound. Therefore, an animal's weight is determined and that weight is multiplied by the live animal value, to determine a price for the animal.

The TRV is preferably based upon the most recent composite retail price survey posted by the U.S.D.A. but can be based upon other standardized retail indicators. An average choice retail price per pound is reported in United States dollars per pound. The average choice retail price per pound is multiplied by a retail yield adjustment factor of 427, to account for meat packing efficiencies and provide a retail beef price for a standard 1000 lb steer.

The composite retail price survey cannot be used alone, since it does not account for a value of byproducts. Therefore, a publically available wholesale byproduct value, also provided by the U.S.D.A., is added to the composite retail price survey to form the TRV. The byproduct value is also reported in dollars per pound. The byproduct value is therefore multiplied by 1000, to provide a retail byproduct price for the standard 1000 lb steer.

The retail beef price and the retail byproduct price for the standard 1000 lb steer are added to form the TRV. The TRV is multiplied by a total retail value coefficient (TRVc). The TRV will have a positive influence on the live animal value. Therefore, the TRVc is a positive coefficient.

Altenatively, TRV can be based upon information supplied by an objective observer. For instance, it is common for cattle producers and beef processors to agree to use a third party consulting firm to help them determine beef prices.

The WPA is used to account for supply factors and includes a weekly beef production (WBP) and a weekly beef production coefficient (WBPc). The USDA also provides information on millions of pounds of beef produced. This information is preferably used as the WBP. The WBP will negatively influence the live animal value. Therefore, the WBPc is a negative coefficient.

The ECA is used to account for energy costs associated with processing and transporting beef and includes an energy cost index (ECI) and an energy cost index coefficient (ECIc). The United States Department of Commerce (U.S.D.C.) provides information on energy costs including a consumer price index of energy. This information is preferably used as the ECI. Energy costs will negatively influence the live animal value. Therefore, the ECIc is a negative coefficient.

The LCA is used to account for labor costs associated with processing beef and comprises a labor cost index (LCI) and a labor index coefficient (LCIc). The U.S.D.C.'s Bureau of Labor Statistics provides information on average hourly wages paid to meat packing workers. This information is preferably used as the LCI. Labor costs will negatively influence the live animal value. Therefore, the LCIc is a negative coefficient.

The IRA is used to accountfor lost rates of return on fund tied up in large inventories rather than being invested and includes an interest rate index (IRI) and an interest rate index coefficient (IRIc). The United States Federal Reserve provides a prime rate. The United States Federal Reserve prime rate is preferably used as the IRI. Lost rates of return will negatively influence the live animal value. Therefore, the IRIc is a negative coefficient.

The FCA is used to account for feed costs associated with feeding animals and includes a feed cost index (FCI) and a feed cost index coefficient (FClc). The USDA conducts a weekly composite corn survey. A local corn price is reported in dollars per bushel and multiplied by 100 to yield a price for 100 bushels of corn. The price for 100 bushels of corn is preferably used as the FCI. Feed costs will negatively influence the live animal value. Therefore, the FCIc is a negative coefficient.

Cattle producers that believe their animals will be worth more next week are likely to hold their animals until next week instead of selling them this week. Therefore, there must be some way to accommodate an expected future animal value. However, the expected future animal value must be objective and measurable.

The EVA is used to account for the expected future animal value and includes an expected value index (EVI) and an expected value index coefficient (EVIc). Initially, cattle futures contract prices as traded on the Chicago Mercantile Exchange (C.M.E.) were directly used as the EVI. This gave cattle futures contract prices a large influence on the live animal price. Having the live animal value closely tied to the expected future animal value can lead to abnormal results. Therefore, this was discounted.

Better results were obtained using a difference in a live cattle value from a previous week and a nearby live cattle futures contract price as traded on the C.M.E. as the EVI. This allows the EVA to account for a known previous value as well as a predicted future value.

Additionally, while these adjustments account for variations in supply, cost, and other factors, it has been found that a constant value (CV) is also needed. The CV provides a standard off set to the live animal value and prevents the TRV or the adjustments from invalidating the live animal value, when one factor experiences an abnormal variance.

In developing the method, an iterative regression analysis was performed, analyzing data from a period beginning in January 1991 and ending in December 2000. Variations in the TRV, the WPA, the ECA, the LCA, the IRA, the FCA, the EVA, as described above, were found to closely track an average historic live animal value (HLAV), when properly combined.

Initially, a relationship between the TRV and the HLAV was analyzed. Regression analysis yielded the following formula:

HLAV=0.06*TRV−13.56

This formula was found to track the HLAV with large errors, since it only accounts for a demand factor. The large errors are a result of influences of supply, cost, and other factors.

In an effort to account for supply as well as demand, a relationship between the TRV, the WPA, and the HLAV was analyzed. Regression analysis yielded the following formula:

HLAV=0.1455*TRV−0.8787*WBP+55.2484

While better than the previous formula, this formula was also found to track the HLAV with errors. The errors are a result of influences of cost and other factors.

Next, in an effort to account for energy and labor costs, a relationship between the TRV, the WPA, the ECA, the LCA, and the HLAV was analyzed. Regression analysis yielded the following formula:

HLAV=0.213695*TRV−0.04375*WBP−0.35526*ECI−3.48987*LCI+89.5103

This formula was still found to track the HLAV with errors. The errors are a result of influences of other factors.

Next, in an effort to account for interest rate fluctuations, a relationship between the TRV, the WPA, the ECA, the LCA, the IRA, and the HLAV was analyzed. Regression analysis yielded the following formula:

HLAV=0.257902*TRV−0.03057*WBP−0.39642*ECI−2.54076*LCI−1.92557*IRI+77.9

This formula was still found to track the HLAV with errors. The errors are a result of influences of still other factors.

Next, in an effort to account for feed prices, a relationship between the TRV, the WPA, the ECA, the LCA, the IRA, the FCA, and the HLAV was analyzed. Regression analysis yielded the following formula:

HLAV=0.274001*TRV−0.01973*WBP−0.37811*ECI−4.33327*LCI−1.5711*IRI−0.02683*FCI+87.82274

This formula was still found to track the HLAV with errors. The errors are a result of influences of future expectations.

Finally, in an effort to account for future expectations, a relationship between the TRV, the WPA, the ECA, the LCA, the IRA, the FCA, the EVA, and the HLAV was analyzed. Regression analysis yielded the following formula:

HLAV=0.083*TRV−0.01376*WBP−0.38031*ECI−4.4605*LCI−1.23425*IRI−0.01248*FCI+0.455982*EVI+73.74

This formula was found to track the HLAV very closely. Since this formula accurately tracks historic prices, it is well suited to estimating future live animal value.

The method of the present invention therefore comprises using the following formulas to calculate the live animal value:

Live Animal Value=TRVc*TRV+WPA+ECA+LCA+IRA+FCA+EVA+CV

Or,

Live Animal Value=TRVc*TRV+WBPc*WBP+ECIc*ECI+LCIc*LCI+IRIc*IRI+FCIc*FCI+EVIc*EVI+CV

As shown by regression analysis, TRVc is 0.083, WBPc is 0.01376, ECIc is−0.38031, LCIc is −4.4605, IRIc is−1.23425, FCI is−0.01248, EVIc is +0.455982, and CV is +73.74. Which leads to a final formula:

Live Animal Value=0.083*TRV−0.01376*WBP−0.38031*ECI−4.4605 *LCI−1.23425*IRI−0.01248*FCI+0.455982*EVI+73.74

While the present invention has been described above, it is understood that substitutes can be made. For instance, future markets may evolve so that one or more of the adjustments are no longeradequate, requiring additional or replacement adjustments to be used. Additionally, the method may be used with other products of a commodity origin, such as, agricultural products, energy products, metals, and/or other related commodities. Furthermore, using the method with other products may require other factors to be considered. These and other minor modifications are within the scope of the present invention.

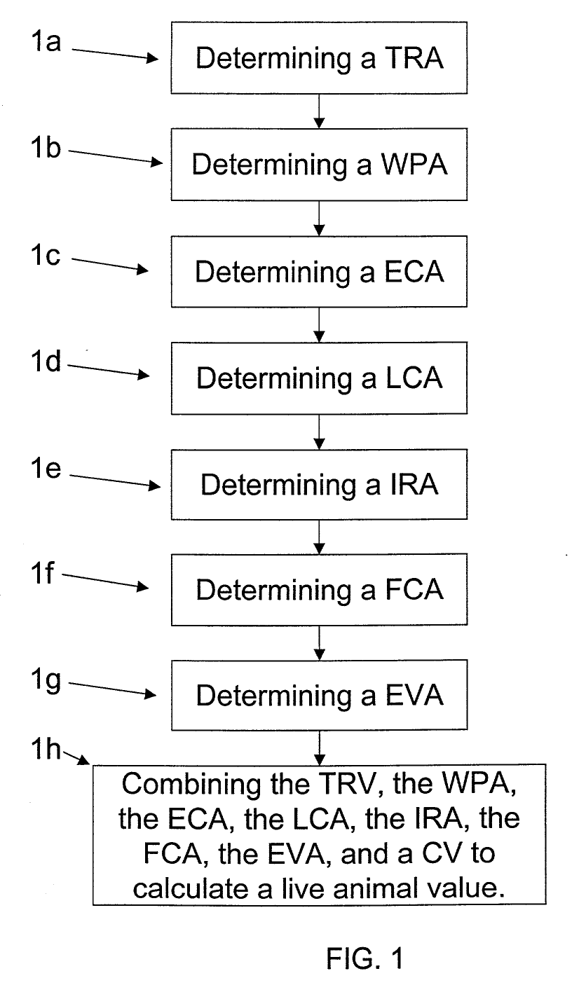

The flow chart of FIG. 1 shows the functionality and operation of a preferred implementation of the present invention in more detail. In this regard, some of the blocks of the flow chart may represent a module segment or portion of code of a program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

In use, as shown in FIG. 1, the TRA is determined by multiplying the TRV by the TRVc, as depicted in step 1a. The WPA is determined by multiplying the WBP by the WBPc, as depicted in step 1b. The ECA is determined by multiplying the ECI by the ECIc, as depicted in step 1c. The LCA is determined by multiplying the LCI by the LCIc, as depicted in step 1d. The IRA is determined by multiplying the IRI by the IRIc, as depicted in step 1e. The FCA is determined by multiplying the FCI by the FCIc, as depicted in step 1f. The EVA is determined by multiplying the EVI by the EVIc, as depicted in step 1g. Finally, the live animal value is calculated by combining the TRA, the WPA, the ECA, the LCA, the IRA, the FCA, the EVA, and the CV, as depicted in step 1h.

The live animal value can be adjusted according to an animal's individual merits of quality and is a price per one hundred pounds. The animal's weight is determined and that weight is multiplied by the live animal value, to determine a price for the animal.

For example, given $3.25 per pound as the average choice retail price and $0.095 per pound as the byproduct value, TRV is calculated by the formula:

TRV=427*average choice retail price+1000*byproduct value

Or,

TRV=427*3.25+1000*0.095=1387.75+95=1482.75

Continuing the example, given 407,700,000 pounds of beef produced in the previous week, WBP is 407.7. Given $128.90 as the consumer price index of energy, ECI is 128.9. Given $10.92 as the average hourly wages paid to meat packing workers, LCI is 10.92. Given 8.5% as the United States Federal Reserve prime rate, IRI is 8.5. Given $2.11 as the local corn price per bushel, FCI is 211. Given $78.27 as the live cattle value from the previous week and $79.50 as the nearby live cattle futures contract price, EVI is −1.23. Using the above values, the live animal value can be calculated with the formula:

Live Animal Value=TRVc*TRV+WBPc*WBP+ECIc*ECI+LCIc* LCI+IRIc*IRI+FCIc*FCI+EVIc*EVI+CV

Or,

Live Animal Value=0.083*TRV−0.01376*WBP−0.38031*ECI−4.4605*LCI−1.23425*IRI−0.01248*FCI+0.455982*EVI+73.74

Or,

Live Animal Value=0.083*1482.75−0.01376*407.7−0.38031*128.9−4.4605*10.92−1.23425*8.5−0.01248*211−0.455982*1.23+73.74

Or,

Live Animal Value=123.06825−5.609952−49.021959−48.70866−10.491125−2.63328−0.56085786+73.74=$79.78 per one hundred pounds

Thus, for a 900 pound steer, the beef processor would be expected to pay the cattle producer $718.02, which is 9 multiplied by $79.78 per one hundred pounds. For a pen with 100 head of cattle that average 950 pounds each, the beef processor would be expected to pay the cattle producer $75,791, which is 100 head multiplied by 9.5 multiplied by $79.78 per one hundred pounds.

Having thus described a preferred embodiment of the invention, what is claimed as new and desired to be protected by Letters Patent includes the following:

1. A method for determining a price for a product being sold by a producer to a processor that accounts for demand, supply, cost, and other factors, the method comprising the steps of:
determining a retail value of the product, wherein the retail value is defined by recent retail sales of the product to consumers;
adjusting the retail value to account for current supply levels of the product; and
adjusting the retail value to account for a set of factors associated with providing the product to consumers.

2. The method as set forth in claim 1, wherein the retail value is objectively determined.

3. The method as set forth in claim 2, wherein the impartial entity is a governmental agency.

4. The method as set forth in claim 1, wherein the set of factors includes costs of preparing the product for retail.

5. The method as set forth in claim 4, wherein the costs include energy costs associated with preparing the product for retail.

6. The method as set forth in claim 4, wherein the costs include transportation costs associated with transporting the product.

7. The method as set forth in claim 4, wherein the costs include labor costs associated with preparing the product for retail.

8. The method as set forth in claim 1, wherein the current supply levels are defined by recent production rates.

9. The method as set forth in claim 1, wherein the set of factors includes current interest rates.

10. The method as set forth in claim 1, wherein the set of factors includes an estimated future value adjustment.

11. The method as set forth in claim 10, wherein the estimated future value adjustment is a determined by a recent price of the product and a futures contract price of the product.

12. The method as set forth in claim 1, wherein the product is of a commodity origin selected from the group consisting of: agricultural products, energy products, and metals.

13. A method for determining a live animal value for livestock for accounting for demand, supply, cost, and other factors, the method comprising the steps of:
determining a retail value of a plurality of products of an animal;
adjusting the retail value for a set of costs associated with preparing the animal for retail; and
adjusting the retail value for at least one supply factor.

14. The method as set forth in claim 13, wherein the retail value is derived from publically posted figures.

15. The method as set forth in claim 13, wherein the plurality of products include meat and byproducts.

16. The method as set forth in claim 13, wherein the set of costs include energy costs associated with preparing the products for retail, transportation costs associated with transporting the products, and labor costs associated with preparing the products for retail.

17. The method as set forth in claim 13, wherein the set of costs include feed costs associated with feeding the animal.

18. The method as set forth in claim 13, wherein the supply factor is recent production rates.

19. The method as set forth in claim 13, further including the step of adjusting the retail value for current interest rates.

20. The method as set forth in claim 13, further including the step of adjusting the retail value for an estimated future value of the animal.

21. A method for determining a live animal value for livestock accounting for demand, supply, cost, and other factors, the method comprising the steps of:
determining a retail value from publically posted figures for products of an animal;
adjusting the retail value to create a retail value adjustment;
determining a weekly production rate from publically posted figures;
adjusting the weekly production rate to create a weekly production rate adjustment;
determining a energy cost from publically posted figures;
adjusting the energy cost to create an energy cost adjustment;
determining a labor cost from publically posted figures;
adjusting the labor cost to create a labor cost adjustment;
determining an interest rate factor from publically posted figures;
adjusting the interest rate factor to create an interest rate adjustment;
determining a feed cost from publically posted figures;
adjusting the feed cost to create a feed cost adjustment;
determining a futures basis from publically posted figures;
adjusting the futures basis to create a futures basis adjustment; and
combining the retail value adjustment, weekly production rate adjustment, energy cost adjustment, labor cost adjustment, interest rate adjustment, feed cost adjustment, and futures basis adjustment with a base value.
